(19) United States
(12) Patent Application Publication
(10) Pub. No.: US 2008/0110518 A1
(43) Pub. Date: May 15, 2008

(54) Gas conduit system

(76) Inventor: Timothy Hamilton, Troy, MO (US)

Correspondence Address: STINSON MORRISON HECKER LLP;F/K/A BLUMENFELD, KAPLAN & SANDWEISS, P.C., 168 NORTH MERAMEC, 4TH FLOOR, CLAYTON, MO, 63105-3763, US

(21) Appl. No.: 11/416,023

(22) Filed: May 2, 2006

(51) Int. Cl. F16L 11/00

(52) U.S. Cl. 138/135; 138/109

(57) ABSTRACT

A gas conduit is shown that provides a fully interlocking metal inner core and a flexible outer jacket. The fully interlocking nature of the inner core prevents or minimizes leaks in the event that the outer jacket is damaged or destroyed, for instance from exposure to an open flame. Interlocking end fittings are used, which do not depend on any rubber or thermoplastic for retention to the tubing/core. Thus, even when exposed to an open flame, the fittings remain in place and relatively leak tight. An indoor version is also shown, which additionally comprises a flexible inner tube disposed within the metal core.

### CROSS REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention relates generally to gas conduits used in connecting appliances to gas fuel sources, and more specifically to such a conduit with improved flexibility and leak resistance.

2. Description of the Prior Art

Indoor and outdoor gas appliances need a connection to a fuel source (i.e. natural gas or propane) to operate. Common fuel sources include natural gas piping systems (such as those found in houses) and propane tank regulators. Currently, such conduits typically fall into one of three categories: rubber hoses, strip wound hoses, and all-metal hoses.

The rubber (or thermoplastic) hose is conventionally an elastomeric or polymer tube with a fiber reinforcement covered with a second layer of non-reinforced elastomeric or polymer material to produce a smooth outer finish. At the ends of the hose are end fittings attached using barb stem inserts that are held in place by die upsetting a metal shell over the hose and insert. The insert then relies on the compressive forces produced from maintaining a squeeze on the rubber hose for its pull-off resistance and leak tightness.

The strip wound hose has an inner core made of an interlocking metal strip with interconnecting helical turns. The core is then covered with a layer of rubber or polymer material to create a leak tight outer tube. The hose ends have fittings attached, which each have an integral shell that is held in place by die upsetting the metal shell over the hose. This type of fitting also relies on compressive forces for pull-off resistance and leak tightness.

Indoor gas appliances commonly use the all-metal hose. It is a copper or stainless steel tube that is mechanically corrugated to make it flexible. The ends have female swivel nuts held in place by welding or mechanically upsetting the end of the tube to form a flare ring. A mating adapter is then screwed into the swivel nut, creating compressive against the flare ring to, and thus a supposedly leak tight seal.

The rubber, thermoplastic, and strip wound type hoses are typically used on outdoor appliances, in close proximity to the burner box, with little protection to prevent exposure to direct sunlight. In the case of longer hoses, they are also prone to coming in contact with the hot surfaces. Therefore, they are often subject to prolonged exposure to elevated temperatures from thermal radiation or making contact with one of the hot surfaces. The most common failures of outdoor connectors come from mechanical failure such as a leak, break, or loss of end fitting retention. Without any mechanism in place to control leakage, or to prevent breakage or end fitting retention loss, these type of failure may result in a fire or explosion.

Many codes currently require all-metal hoses for indoor use. However, the all-metal connector is prone to cracking from repeated bending, movement, and/or vibration. This has led to a recent revision in the Canadian gas code, banning the use of all-metal hoses in conjunction with infrared tube heaters because of cracking problems caused by constant expansion and contraction of the hoses due to their proximity to the heaters. This has also caused the warning labels for such hoses to advise against moving the appliance after installation and against reusing the connector if and when the appliance is relocated.

Thus, it is an object of the present invention to provide a gas conduit that overcomes the deficiencies of the prior art.

It is another object of the present invention to provide such a conduit with improved leak resistance.

It is a further object of the present invention to provide such a conduit with end fittings that do not rely on elastomeric or polymer materials for end fitting retention.

It is yet a further object of the present invention to provide such a conduit made not entirely of metal.

It is still a further object of the present invention to provide such a conduit suitable of indoor or outdoor use.

### SUMMARY OF THE INVENTION

It was with the above objects in mind that the present invention was conceived and developed. The present invention combines some of the features of the prior art hoses in a novel and ingenious way. It uses an inner core made of helically coiled interlocking strips, where the strips are fully interlocking. “Fully interlocking” is different from some use of “interlocking” metal cores found in the prior art. Previous uses of “interlocking” metal cores in this field involved the use of square locks (see FIG. 1). The present invention uses full interlocking of the strips of the helical coil. That is, the ends of each strip overlap with the adjacent strip, maintaining contact therewith (or a very small clearance).

The present invention also uses interlocking end fittings. These fittings are threaded on the interior surface and do not rely on rubber or thermoplastic for retention, and therefore do not lose retention strength if exposed to an open flame. Also found in the present invention is an outer cover made of a flexible material.

The present invention may also use flexible inner tubing, making it suitable for indoor-use. It is also preferable to use seal beads on the interior surface of the end fittings. The seal beads contact with the outer cover, thereby improving the leak tight nature of the seal.

The resulting is suitable as a gas conduit for low pressure applications (<5 psi, or <250 psi if an inner liner is used). It remains flexible, yet even when exposed to an open flame (thus destroying the outer jacket) will have only minimal leakage—1 cubic foot per hour (CFH) or less pre foot of exposed core. Additionally, the end fittings are not prone to coming loose even after exposure to an open flame.

### DESCRIPTION OF THE DRAWINGS

So that the manner in which the above-identified features, advantages, and objects of the present invention are attained and can be understood in detail, a more particular description of the invention, briefly summarized above, may be had by reference to the embodiment thereof which is illustrated in the appended drawings.

It is noted however, that the appended drawings illustrate only a typical embodiment of this invention and is therefore not to be considered limiting of its scope, for the invention may admit to other equally effective embodiments. Reference the appended drawings, wherein:

FIG. 1 is a cutaway view of a prior art gas conduit, showing a square locks metal inner core;

FIG. 2 is an isometric, partial cutaway, exploded view of the gas conduit of the present invention for use in outdoor applications;

FIG. 3 is an isometric, partial cutaway, exploded view of the gas conduit of the present invention for use in indoor applications; and

FIG. 4 is a sectional view showing the details of the fully interlocking metal core of the present invention.

FIG. 5 is a sectional view of a gas hose fitting for an outdoor connector of the present invention.

FIG. 6 is a sectional view of a gas hose fitting for an indoor connector of the present invention.

### DETAILED DESCRIPTION OF A PREFERRED EMBODIMENT OF THE INVENTION

Referring now to FIG. 2, the gas conduit 10 of the present invention is shown generally. The conduit 10 comprises an inner metal core 12, which is helically wound. Each strip 14 of the core 12 is fully interlocking with the adjacent strip 14. The precise meaning of fully interlocking will be discussed in more detail below. The conduit 10 also comprises an outer jacket 16 disposed about the core 12. A portion 18 of the core 12 at each end is exposed, extending beyond the outer jacket 16. This can easily be accomplished during manufacturing by simply removing the necessary portion of the outer jacket 16. By way of example, in a conduit with an inside diameter of ⅜″, the exposed portion 18 of the core 12 at either end will typically be approximately ¼″.

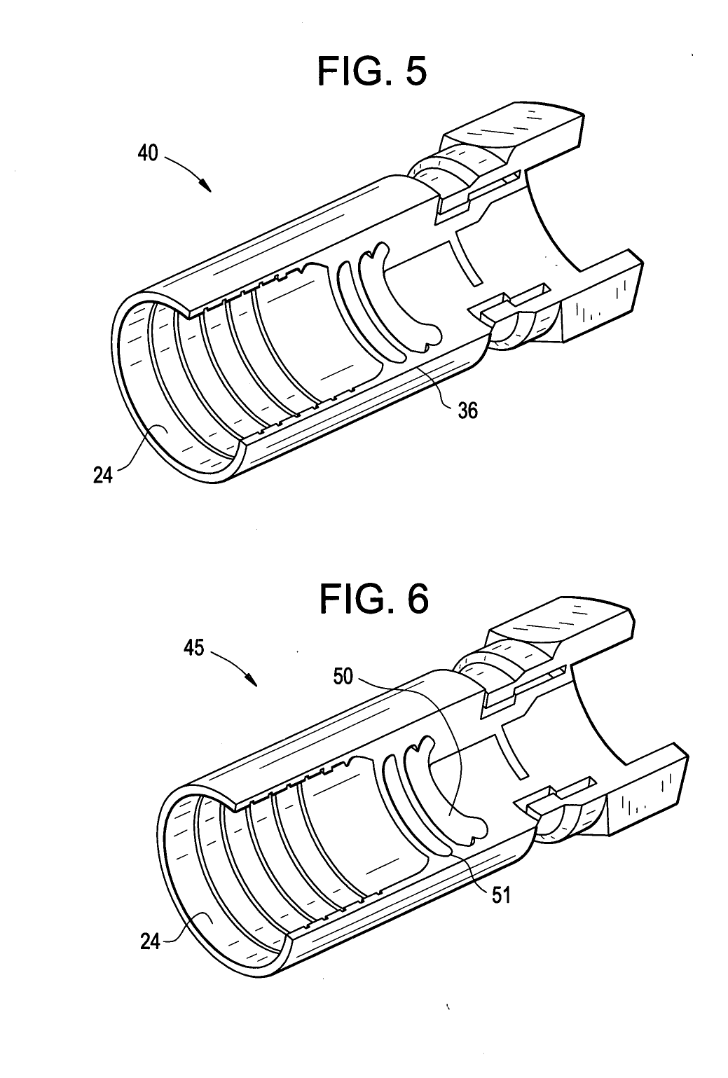

Fittings 20, 22 are placed on either end of the metal core 12. The exact type of fittings 20, 22, used is not important, and can be made to fit any industry standard. The important aspect of the fittings 20, 22, is that they have threading 24 on the inner surface thereof, the threading 24 designed and sized to fit the outside of the fully interlocking metal core 12. Seal beads 26 on the inside of the fittings 20, 22 are positioned to overlap, and thus engage the outer jacket 16. FIG. 5 discloses one embodiment of an outdoor gas hose connector 40 of the present invention that is generally intended for outdoor use. FIG. 6 discloses an indoor gas hose fitting 45 that is generally intended for use with indoor applications. The indoor gas hose fitting 45 is substantially the same as the outdoor gas hose fitting 40, but also includes a seal bead 50 and an inner tube gland 51 that enhances the sealing properties of the connector for indoor use.

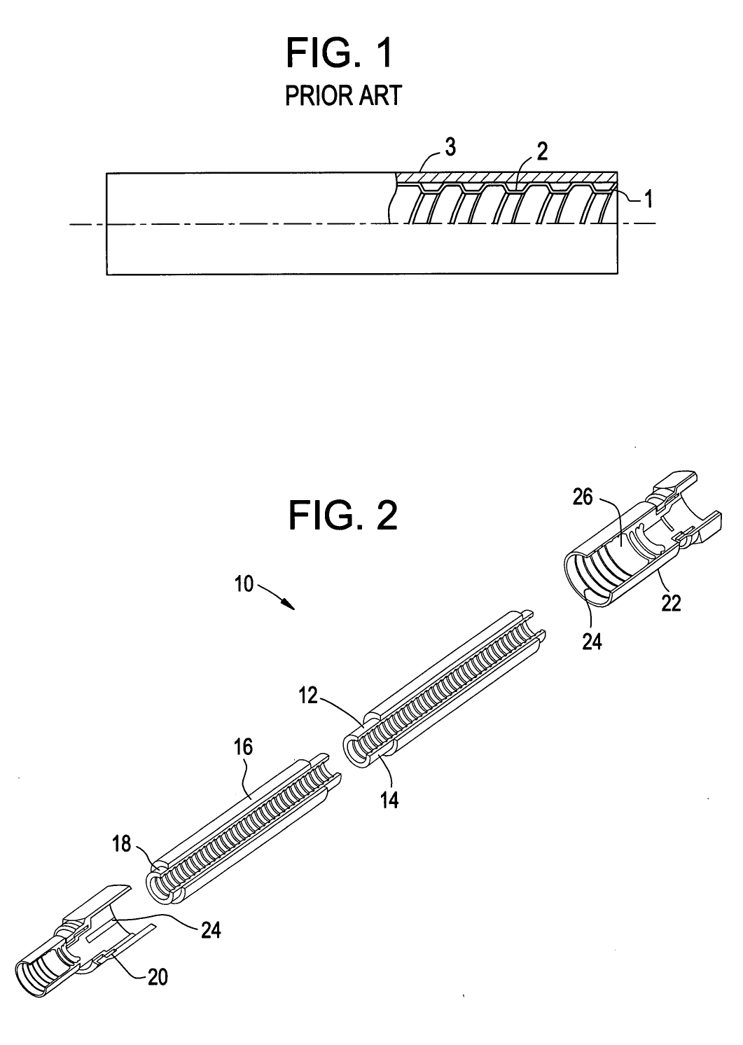

Turning now to the inner core 12 in more detail, the configuration of the fully interlocking strips 14 can be seen in more detail in FIG. 4. This fully interlocking configuration should be compared to the square interlocking seen in the prior art and in FIG. 1. It should be noted that in the fully interlocking configuration critical to the present invention, the edge 28 of each strip 14 completely overlaps and wraps around each adjacent strip 14. Thus, the overlap at the junction 30 of any two strips is minimum four times the thickness of the core 12 material.

In the prior art, a metal core 1 is coiled so that each strip 2 barely overlaps (and then only in single manner—thus, the overlapping portion is only two times the thickness of the core 1 material. Most importantly, this configuration results in gaps forming between the strips 2 when the core 1 is flexed. Conversely, the strips 14 of the fully interlocking core 12 are always in contact with each other when the core 12 is flexed—or at the most, there is a small clearance on the order of (0.002″). To compare the effectiveness of the two configurations, when the outer jacket 3 is removed from the core 1 of the square locking configuration (e.g. from exposure to an open flame), the result is a significant leak which will vary with the exact type of square lock use, but will typically be in excess of 5 CFH per foot of exposed core 1. As mentioned above, the fully interlocking configuration without an outer jacket 16 maintains leak rates at or below 1 CFH per foot of exposed core 12. It should be noted that the use of fully interlocking configurations in metal conduit have been around for years in applications unrelated to the present invention, and the manufacture of such a configuration is generally known to those of ordinary skill in the art of hose manufacturing (see, e.g., U.S. Pat. No. 6,311,736 to Herman et al.).

The inner core 12 may be made of a variety of materials, but the preferred material is galvanized steel with an electrolytic zinc coat. A steel thickness of 0.013″ is typical. The resulting pitch of the coil is 0.156″, where each interlocking junction 30 is no more than 0.125″ wide. A ⅜″ nominal inner diameter core will have an outer diameter of approximately ½″.

The outer jacket 16 may be made from an array of flexible materials, such as a thermoplastics or rubber. The inventor has found the preferred material to be a poly-vinyl chloride (PVC), which should be self-extinguishing and resistant to ultra-violet light and ozone. A typical outer diameter of the jacket 16 for the core 12 with an inner diameter of ⅜″ (and thus a core 12 outer diameter of ˜½″) will be ⅝″. While the present invention can be made in a variety of sizes, the most typical sizes will range from ¼″ to 2″ in inner diameter. However, conduits can be made somewhat smaller or larger than this range without departing from the scope of the invention.

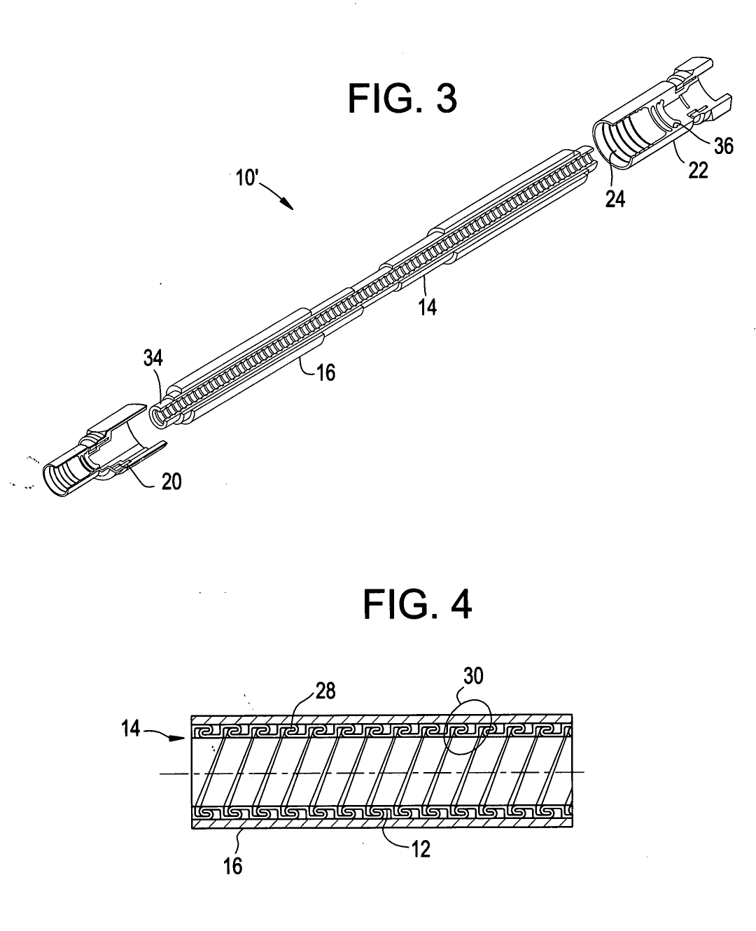

The fittings 20, 22, again, may be made from a number of materials, and may be made to fit any standard. Shown in FIGS. 2 and 3 are SAE swivel connectors (typically made of brass), which are common in the industry. Although in special applications two male fittings or two female fittings may be used, the typical conduit 10 will have a male connector fitting 20 and a female connector fitting 22. Each fitting 20, 22 has a threaded inner surface 24. The threading 24 is especially designed with a profile to engage the interlocking junctions 30 on the exposed portion 18 of the inner core 12. The inside ends 32 of the fittings 20, 22 will overlap the start of the outer jacket 16. Thus, it is preferable to have seal beads 26 disposed inside the fittings 20, 22 to engage the outer jacket 16. This improves the leak tightness at the fittings 20, 22.

The interlocking nature of the fittings 20, 22, combined with the fully interlocking inner core 12, result in a strong fit between the components. The outer jacket 16 is not depended upon to provide any retention strength, thus even when exposed to an open flame, the fittings 20, 22 will stay in place with minimal, if any, leaks. The leak tightness and the retention strength of the fittings 20, 22 is preferably further improved by crimping the fittings 20, 22 on the remainder of the conduit 10 after installation. Additional safety may be obtained from applying a high temperature adhesive to the threading 24 before installation.

FIG. 3 shows another version of the conduit 10′ designed for indoor applications. The differences between the indoor conduit 10′ and the outer conduit 10 are minimal, and therefore the basic structure will not be repeated. The indoor conduit 10′ includes two additional components. An inner tube 34 is disposed inside the metal core 12. The inner tube 34 is made from a flexible material, preferably a thermoplastic or elastomer. The indoor conduit 10′ also includes seal glands and retainers 36 inside the fittings 20, 22. These retainers 36 engage the outside of the inner tube 34, which extends slightly beyond the inner core 12. Because indoor conduits are currently all-metal in this country, the present invention solves the problem of failure due to mechanical vibration in such indoor applications, which is not uncommon.

While the foregoing is directed to the preferred embodiments of the present invention, other and future embodiments of the invention may be devised without departing from the basic scope thereof, and the scope thereof is determined by the claims which follow.

What is claimed is:

1. A gas conduit, comprising:
a helically wound metal inner core having a plurality of strips within the helix, each strip configured to be fully interlocking with the adjacent strips;
a flexible outer jacket disposed about the outside of said inner core; and
at least one fitting threaded onto an end of said inner core.

2. The gas conduit of claim 1, wherein said inner core has two ends, each end having one of said fittings threaded thereon.

3. The gas conduit of claim 2, having an exposed portion on each end of said inner core, wherein an outer surface of said inner core extends beyond said outer jacket.

4. That gas conduit of claim 3, wherein said fittings overlap said outer jacket when fully threaded onto said inner core.

5. The gas conduit of claim 4, further comprising a plurality of seal beads disposed inside each fitting, said seal beads engaging said outer jacket.

6. The gas conduit of claim 3, further comprising a flexible inner tube disposed inside said inner core.

7. The gas conduit of claim 6, wherein portions of said inner tube extend beyond said inner core.

8. The gas conduit of claim 7, further comprising a retainer disposed on the inside of each fitting, said retainers engaging said portions of said inner tube extending beyond said inner core.

9. The gas conduit of claim 3, wherein one fitting is a male connector and one fitting is a female connector.

10. The gas conduit of claim 3, further comprising an adhesive applied to threading of said fittings or said exposed portions of said inner core.

11. The gas conduit of claim 1, wherein each strip has an edge that wraps around at least a part of an edge of any adjacent strips.

12. The gas conduit of claim 11, wherein a single helical continuous junction is formed comprising the overlapping portions of each strip of the helix of said inner core, and wherein continuous contact is maintained between each strip at said junction.

13. The gas conduit of claim 12, wherein said junction comprises a four-ply overlap of the material forming said inner core.
